(19) United States
(12) Patent Application Publication
(10) Pub. No.: US 2007/0136474 A1
(43) Pub. Date: Jun. 14, 2007

(54) Method and apparatus to facilitate provision of a call-specific logic operator

(75) Inventors: Sundar Raman, Chicago, IL (US); Quan Choi, Port Barrington, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc., Alameda, CA (US)

(21) Appl. No.: 11/294,927

(22) Filed: Dec. 6, 2005

(51) Int. Cl. G06F 15/16

(52) U.S. Cl. 709/227; 709/217

(57) ABSTRACT

A network element (501) can determine (101) a substantially present need to support a communication for a communication system user (507) and receive (102), from a remote location (504), information regarding at least one call-specific logic operator to be employed when supporting the communication for the communication system user. Such information can assume a variety of forms depending upon the preferences and/or requirements of a given application setting but generally serve to dynamically provision the network element with one or more logic operators (as may relate, for example, to quality of service) that the network element is not otherwise pre-provisioned with.

### TECHNICAL FIELD

This invention relates generally to communications and more particularly to communications as are supported by one or more network elements.

### BACKGROUND

Modem communications environments often present a relatively complex and typically dynamic operational context. For example, numerous variable conditions exist that can greatly alter an available level of quality of service as may be attainable at any given time for a given communication system user. In attempt to better accommodate such variable conditions, some communication systems permit a network element such as a Packet Data Serving Node to be programmed using pre-provisioned logic operators and one or more corresponding threshold values. So configured, the network element is sometimes able to alter support circumstances for a given communication session in response to changing conditions. For example, such a network element can be programmed to automatically provide predetermined limits with respect to communication sessions when system loading reaches or exceeds a given predetermined threshold.

Current CDMA2000 architecture represents an illustrative example in this regard. Such an architecture often provides for using an Authentication, Authorization, and Accounting network element to store a communication system user's quality of service profile. The latter typically comprises one or more constraints that shall apply to that user's sessions. Such constraints might comprise, for example, performance limits that may apply via Differentiated Services Code Point (DSCP) markings, limits with respect to the applications (or types of applications) to which the user may subscribe, and so forth.

While offering an improvement over more static approaches, the above-mentioned pre-provisioning and proscribed usage techniques are still nevertheless significantly limited with respect to permitting sufficient agility to satisfactorily meet the large number of contingencies that can arise during the course of a given communication session. In particular, techniques such as those noted above tend to be static in configuration and application. As a result, conditions can arise where such statically configured tests, triggers, and/or responses are not particularly helpful or may even lead to degraded session and/or network conditions.

### BRIEF DESCRIPTION OF THE DRAWINGS

The above needs are at least partially met through provision of the method and apparatus to facilitate provision of a call-specific logic operator described in the following detailed description, particularly when studied in conjunction with the drawings, wherein:

FIG. 1 comprises a flow diagram as configured in accordance with various embodiments of the invention;

FIG. 2 comprises a schematic view of a message format as configured in accordance with the prior art;

FIG. 3 comprises a schematic view of a message format as configured in accordance with various embodiments of the invention;

FIG. 4 comprises a schematic view of a message format as configured in accordance with various embodiments of the invention;

FIG. 5 comprises a block diagram as configured in accordance with various embodiments of the invention; and

FIG. 6 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a network element can determine a substantially present need to support a communication for a communication system user and receive, from a remote location, information regarding at least one call-specific logic operator to be employed when supporting the communication for the communication system user. Such information can assume a variety of forms depending upon the preferences and/or requirements of a given application setting but generally serve to dynamically provision the network element with one or more logic operators (as may relate, for example, to quality of service) and/or the particular logic operators to use which the network element is not otherwise pre-provisioned with.

So configured, a network element can be dynamically provisioned with logic facilities to thereby greatly expand the potential capability of such a network element to better support both the present communication needs of a given user as well as better supporting overall communication network operations. Such dynamic capabilities are exercisable both upon initiation of a given communication session and also during the course of that communication session; for example, as to the latter, the network element can be dynamically provisioned with updated logic operators during the course of an ongoing communication session to permit that network element to better react to then-changing conditions as are tending to characterize that communication session and/or the network itself.

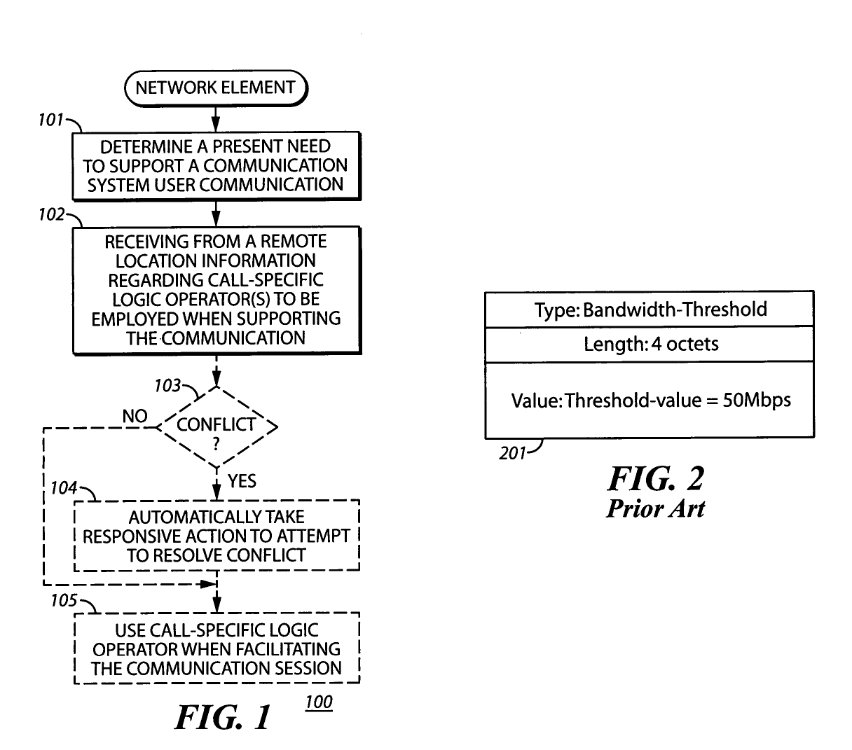

These and other benefits may become clearer upon making a thorough review and study of the following detailed description. Referring now to the drawings, and in particular to FIG. 1, a corresponding illustrative process 100 permits a network element (such as, but not limited to, a Packet Data Serving Node) to determine 101 a substantially present need to support a communication for a communication system user and to then receive 102, from a remote location (such as from an authorization entity such as, but not limited to, an Authentication, Authorization, and Accounting element), information regarding at least one call-specific logic operator to be employed when supporting the communication for the communication system user.

Those skilled in the art will understand and recognize that the expression “logic operator” refers to more than, for example, merely an operand such as a threshold value or the like. A logic operator comprises, for example, a particular operator that is able to derive a particular resultant value or action based upon one or more operands and may also serve to connect given corresponding statements into more complicated compound statements.

This receiving of information regarding one or more call-specific logic operators can be triggered by any of a wide variety of stimuli such as, but not limited to, having sourced an access request on behalf of the communication system user to an authentication entity that, in turn, responds with the session-specific logic operator information. It would also be possible, of course, to receive such information other than in response to sourcing such an access request message. Those skilled in the art will understand and appreciate that such information can be fully or partially pulled and/or pushed in response to any number of triggering circumstances.

When the information is received as a response to having sourced an access request, however, by one approach the information can comprise a part of an access accept message (such as a part of a Remote Authentication Dial-In User Service (RADIUS)-based protocol and/or system). Regardless, by one approach, this information can be provided via a message having a type/length/value format (where type identifies the information being transmitted, length indicates the total length of this unit of information, and value comprises the information itself (often adhering to a 32-bit alignment protocol).

Such type/length/value messages are known in the art with a schematic representation of a prior art example being shown in FIG. 2. The illustrated example message 201 illustrates a prior art approach whereby an element such as an Authentication, Authorization, and Accounting element indicates to a Packet Data Serving Node a particular bandwidth threshold (in this example, 50 Mbps) to employ as a trigger value as corresponds to pre-provisioned logic that the Packet Data Serving Node is pre-configured to employ on a relatively static basis (for example, a Packet Data Serving Node might use such a threshold to identify when a particular pre-defined action is to be taken while facilitating communication sessions).

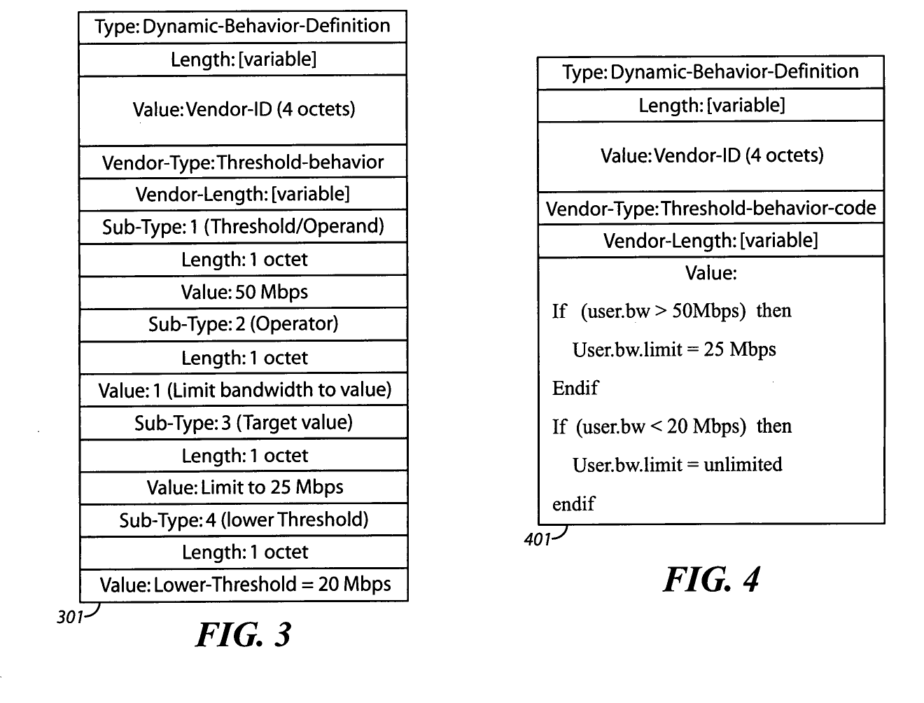

By these teachings, such a type/length/value message format can be extended in purpose and readily employed to convey the aforementioned information as regards at least one call-specific logic operator to be used when supporting a given communication for a given communication system user. To illustrate, and referring now to FIG. 3, an example message 301 as accords with these teachings provides for a plurality of attributes that represent, in the aggregate, a bitmap that defines a corresponding logic statement. In this particular example message 301, this logic comprises:

If the bandwidth for user X exceeds 50 Mbps, then
limit the user's bandwidth to 25 Mbps

If the user hits 20 Mbps, then
remove all limits and allow the user to use maximum bandwidth again.
   Such a capability and capacity, of course, contrasts starkly and dramatically to the more limited operand-bearing nature that characterizes a typical prior art approach. So configured, the sourcing network element can easily vary the logic to be employed by the Packet Data Serving Node on a dynamic basis and without particular concern for what logic the Packet Data Serving Node may already have been pre-provisioned with or otherwise statically programmed to utilize.

Those skilled in the art will recognize and appreciate that extensions to the logic to be communicated are easily implemented (presuming agreement as to a common framework for the logic has been reached as between the sourcing network element and the receiving network element, though even here it would be possible to communicate the characterizing aspects of the framework itself through a similar mechanism).

It would also be possible, of course, to employ these teachings in conjunction with a network element that is pre-provisioned with some or all potentially useful logic operators. In such a case, the aforementioned information regarding the call-specific logic operator (or operators) to use with respect to a given communication session can comprise one or more identifiers as correspond to the particular pre-provisioned logic operators to be presently used. It would also be possible, of course, to combine these approaches and provide both an identifier as corresponds to a particular candidate pre-provisioned logic operator and to provide the definition of an additional logic operator as has been described above in a given instance.

By yet another approach the information conveyed can comprise executable software instructions. To illustrate, and referring now to FIG. 4, the message 401 can comprise an attribute section having a full string of code. (As an alternative approach, if desired, partial strings of code can be conveyed using multiple messages with the resultant partial strings then properly ordered and concatenated to recover the original complete string of code.)

The nature of the logic operator so conveyed can vary with the specific needs or requirements of a given application setting. By one approach, for example, the logic operator can comprise logic to at least partially control quality of service as corresponds to the communication session at issue. It would also be possible, of course, to include with the logic operator one or more operands or identified operands that may be used in conjunction with the provided logic operator(s) (with the two illustrative examples provided above serving as pertinent examples in this regard).

Returning again to FIG. 1, upon receiving such information, the receiving network element may optionally be further configured or programmed to determine 103 whether the corresponding call-specific logic operator conflicts with other pre-provisioned logic to which the network element is to adhere and observe. For example, the receiving network element may have a general quality of service-related tenant that must always be observed and which tenant conflicts with the specifics of the logic operator that has been dynamically provided in a given instance. When such a conflict occurs and is detected 103, by one approach the network element can automatically take responsive action 104 to at least attempt to resolve the conflict.

This can comprise any desired corresponding action. One example would be to permit the statically defined logic to have priority while another approach would permit the dynamically provided logic to temporarily replace the dictates of a conflicting statically defined approach. As another example the network element can be configured and arranged to submit the conflict to an external arbitration element as may be available. Other approaches are available as well as will be understood and appreciated by those skilled in the art.

Having identified the one or more call-specific logic operators to employ when supporting a given communication, by one approach the network element then optionally makes use 105 of that logic operator when facilitating the communication session in question. This can comprise, of course, using a non-pre-provisioned logic operator to facilitate control, at least in part, of a given communication session. This can also comprise, as describe above, using pre-provisioned logic as has been specifically identified for use in this particular communication session in accordance with these teachings.

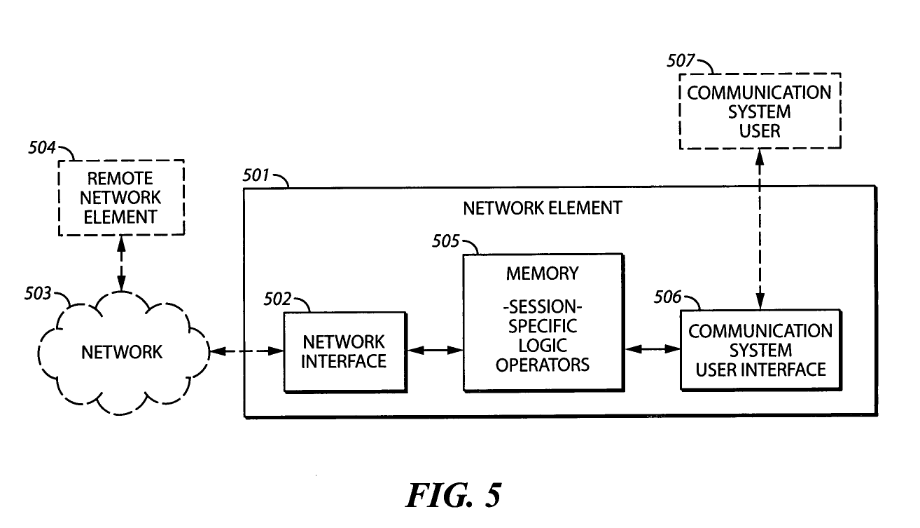

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 5, an illustrative approach to such a platform will now be provided.

In this illustrative example, a network element 501, such as but not limited to a Packet Data Serving Node, comprises a network interface 502 that operably couples to a network 503 (such as, for example, a local area network, a wide area network, or an extranet such as the Internet). So configured, the network interface 502 serves, at least in part, to facilitate communicating with and in particular receiving the above-described information from a remote network element 504 via the noted network 503. This remote network element 504 may comprise, for example, an authorization entity such as, but not limited to, an Authentication, Authorization, and Accounting element as is generally known in the art.

By one approach, this network interface 502 is configured and arranged to compatibly receive a message such as a message having the above-described type/length/value format. It may also be desirable to configure and arrange the network interface 502 to compatibly receive such a message as comprises a part of an access accepted message as may be sourced by the remote network element 504 in response to a user authentication request as may be sourced by the network element 501 itself.

In this embodiment the network element 501 further comprises a memory 505 that operably couples to the network interface 502 such that data corresponding to the information received from the remote network element 504 can be stored therein. In particular, by one approach, information regarding the at least one session-specific logic operator to be employed when supporting a requested communication session for a given communication system user is stored therein to thereby make such information available during the course of facilitating the indicated communication session. In accord with these teachings, this memory 505 can contain such other information as may be useful to effect the purposes taught herein. For example, this memory 505 may contain pre-provisioned logic that, when specifically identified via a message as described above, can then be recalled and used to facilitate a given communication session.

In this embodiment the network element 501 further comprises a communication system interface 506 to facilitate useful interaction with a corresponding communication system user 507. Those skilled in the art will recognize and understand that such an apparatus 501 may be comprised of a plurality of physically distinct elements as is suggested by the illustration shown in FIG. 5. It is also possible, however, to view this illustration as comprising a logical view, in which case one or more of these elements can be enabled and realized via a shared platform. It will also be understood that such a shared platform may comprise a wholly or at least partially programmable platform as are known in the art.

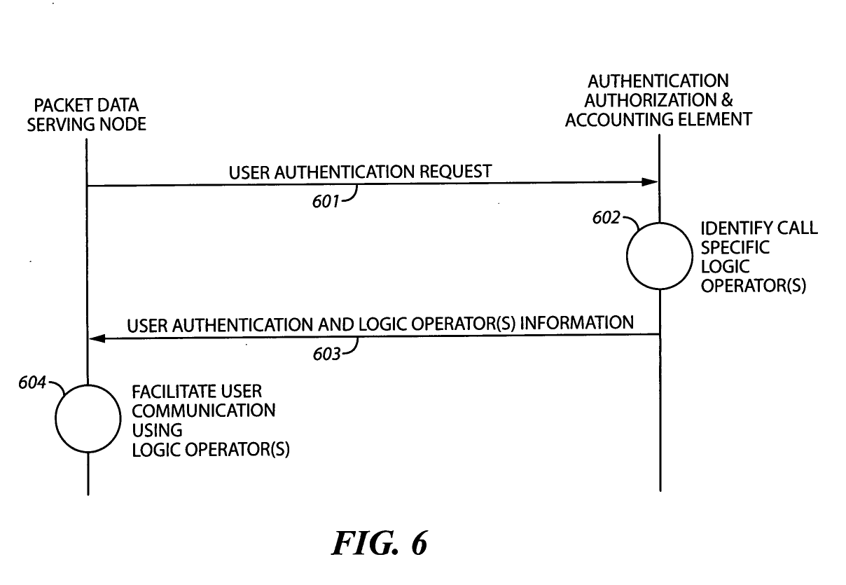

To further illustrate these teachings and referring now to FIG. 6, a Packet Data Serving Node can receive a request (not shown) from a given communication system user to facilitate a given communication session (with such requests being well understood in the art and requiring no further elaboration here). The network element can then transmit a corresponding user authentication request 601 to a selected Authentication, Authorization, and Accounting element (again as is well understood in the art). The Authentication, Authorization, and Accounting element can then identify one or more call-specific logic operators 602 that the Packet Data Serving Node should employ when supporting this particular call. This identification can be made as a function of various criteria of interest, which criteria can change as frequently as may be useful or desired. In particular, this identification of particular logic operators to employ on a call-specific basis can be driven as a function, at least in part, of seeking to maintain some given general system-wide and/or specific-user quality of service experience.

The Authentication, Authorization, and Accounting element then transmits, in this illustrative example, a user authentication message 603 that further serves to convey the above-described information that comprises or identifies the logic operators to be used by the recipient Packet Data Serving Node when facilitating the authorized session. So informed, the Packet Data Serving Node can then facilitate the authorized user communication using the one or more identified logic operators 604.

As already noted above, such dynamic assignment of particular logic operators to use with respect to a given communication session can be provided at the outset of authorizing that communication session. It would also be possible, however, to provide for dynamic alterations to the so-established logic apportionment by providing subsequent logic operator information to the Packet Data Serving Node during the course of the communication session. This can be occasioned in any of a variety of ways. By one example, the authentication entity can unilaterally push such supplemental information to the facilitating network element as a function of information that may be available to the former by whatever means. As another example, the facilitating network element (perhaps in response to noting an initial or developing logic conflict) can contact the authentication entity seeking additional input with respect to the logic to be used for this communication session. Other examples are also possible.

So configured, considerable flexibility now exists to accommodate a wide range of conditions, capabilities, and preferences. Those skilled in the art will appreciate that this flexibility can be wielded in a quick and readily supported fashion. As a result, a system administrator has significantly improved abilities to meet desired goals with respect, for example, to individual and system-wide user experiences.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, if desired, these teachings can be optionally modified to provide for validation of the authenticity and/or authority of the owner of a given logic operator and/or operand. This could comprise, for example, using presently known security association mechanisms to validate, for example, an Authentication, Authorization, and Accounting network element as a prerequisite to receiving and/or complying with reconfiguration information as may be provided thereby. The security association may further be used to validate each logic element, in addition to authenticating the network elements.

We claim:

1. A method comprising:
at a network element:
determining a substantially present need to support a communication for a communication system user;
receiving, from a remote location, information regarding at least one call-specific logic operator to be employed when supporting the communication for the communication system user.

2. The method of claim 1 wherein the network element comprises a Packet Data Serving Node.

3. The method of claim 1 wherein receiving comprises receiving in response to sourcing an access request on behalf of the communication system user.

4. The method of claim 1 wherein receiving comprises receiving other than in response to sourcing an access request message on behalf of the communication system user.

5. The method of claim 1 wherein receiving comprises receiving the information as part of an access accept message.

6. The method of claim 1 wherein receiving comprises receiving the information in a message having a type/length/value format.

7. The method of claim 1 wherein the information comprises an identifier as corresponds to the at least one call-specific logic operator.

8. The method of claim 1 wherein the information comprises executable software instructions.

9. The method of claim 8 wherein the information further comprises at least one identified operand.

10. The method of claim 1 further comprising: at the network element:
determining that the call-specific logic operator conflicts with other pre-provisioned logic;
automatically taking at least one responsive action to at least attempt to resolve the conflict.

11. The method of claim 1 wherein the information further comprises logic to at least partially control quality of service as corresponds to the communication.

12. A method for use at a network element in a communication system when facilitating a communication session on behalf of a communication system user, comprising;
receiving at least one non-pre-provisioned logic operator corresponding to quality of service to use when facilitating the communication session;
using the at least one non-pre-provisioned logic operator when facilitating the communication session.

13. The method of claim 12 wherein receiving the at least one non-pre-provisioned logic operator comprises receiving the at least one non-pre-provisioned logic operator as a part of an access accepted message.

14. The method of claim 12 wherein receiving the at least one non-pre-provisioned logic operator comprises receiving the at least one non-pre-provisioned logic operator subsequent to sourcing a network message regarding the communication system user.

15. The method of claim 12 further comprising also using pre-provisioned logic when facilitating the communication session.

16. The method of claim 12 wherein the at least one non-pre-provisioned logic operator comprises identifying information that identifies pre-provisioned instructions that are already available to the network element.

17. The method of claim 12 wherein the at least one non-pre-provisioned logic operator comprises executable software instructions.

18. A network element comprising:
a network interface;
a communication system user interface configured and arranged to receive a communication session request from a communication system user;
a memory operably coupled to the network interface and having stored therein information received from a remote network element via the network interface regarding at least one session-specific logic operator to be employed when supporting a requested communication session for the communication system user.

19. The network element of claim 18 wherein the network element comprises a packet data serving node.

20. The network element of claim 18 wherein the remote network element comprises an authorization entity.

21. The network element of claim 20 wherein the authorization entity comprises an Authentication, Authorization, and Accounting element.

22. The network element of claim 18 wherein the at least one session-specific logic operator comprises, at least in part, non-pre-provisioned content.

23. The network element of claim 18 wherein the information comprises an identifier that specifies the at least one session-specific logic operator, which at least one session-specific logic operator comprises pre-provisioned content.

24. The network element of claim 18 wherein the information comprises executable software instructions.

25. The network element of claim 18 wherein the at least one session-specific logic operator comprises quality of service control logic.

26. The network element of claim 18 wherein the network interface comprises means for receiving the information from the remote network element in a message.

27. The network element of claim 18 wherein the network interface comprises means for receiving the information from the remote network element in a message having a type/length/value format.

28. The network element of claim 18 wherein the network interface comprises means for receiving the information from the remote network element in an access accepted message.

29. A method to facilitate a quality of service plan with respect to a communication session for a communication system user, comprising: at a first network element:
determining a need to effect a particular quality of service plan with respect to a particular communication session for a particular communication system user;
identifying at least one implementable logic operator to effect the particular quality of service plan;
transmitting information regarding the at least one implementable logic operator; at a second network element:
receiving the information regarding the at least one implementable logic operator;
using the information to facilitate supporting the communication session for the communication system user.

30. The method of claim 29 wherein the second network element comprises a Packet Data Serving Node.

31. The method of claim 29 wherein determining a need comprises receiving from the second network element an access request message as corresponds to the communication system user.

32. The method of claim 29 wherein transmitting information comprises transmitting identifying information and wherein using the information comprises using the information to identify implementable content as is already stored at the second network element.

33. The method of claim 29 wherein transmitting information comprises transmitting executable software and wherein using the information comprises using the executable software.
